(19) United States
(12) Patent Application Publication
(10) Pub. No.: US 2008/0113139 A1
(43) Pub. Date: May 15, 2008

(54) Paper with adhesive

(75) Inventors: Madoka Tokutsu, Osaka (JP); Hiroyuki Kasahara, Osaka (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: KOKUYO Co., Ltd., Osaka (JP)

(21) Appl. No.: 11/979,696

(22) Filed: Nov. 7, 2007

(30) Foreign Application Priority Data
Nov. 13, 2006 (JP) P2006-306636
Aug. 24, 2007 (JP) P2007-218989

(51) Int. Cl. B32B 33/00

(52) U.S. Cl. 428/40.1; 428/42.3

(57) ABSTRACT

The present invention aims to provide a paper with adhesive capable of maintaining predetermined adhesive force without the region corresponding to an adhesive layer curving in use in the paper with adhesive configuring a sticky, the paper with adhesive including an adhering part applied with adhesive and a non-adhering part where a base material is exposed on one surface including a peripheral edge, wherein the adhering part includes a plurality of unit adhering regions applied with adhesive in a set shape and arranged spaced apart from one another and the non-adhering part is formed into a mesh form between the unit adhering regions and also formed along at least one part of the peripheral edge.

### BACKGROUND OF THE INVENTION

1. Field of the Invention

The present invention relates to a paper with adhesive used as, e.g., a marker of a specific page of a book or used as a memo.

2. Background of the Related Art

Conventionally, sticky notes of a stacked body formed by stacking a plurality of paper strips each with an adhesive layer on the back surface is known. In such a sticky note, surface processing such as application of a release agent on the surface is generally performed so that each paper strip with the adhesive layer can be detached sheet by sheet, that is, to enhance the release property of the adhesive layer from the surface of the paper strip. However, although such processing is performed, the detached paper strip may greatly curve at the portion of the adhesive layer. Such curving phenomenon of the paper strip is caused by the fact that the paper strip curves by the force applied on the paper strip when detaching the paper strip, and the curved state is held by the adhesive layer.

In order to resolve such a drawback, a configuration of dividing the adhesive layer in the lateral direction of the paper strip, and alternately arranging the adhesive layer and an exposed part of the surface of the paper strip is adopted in Japanese Examined Utility Model Application Publication No. 03-027816 and the like. In this case, the adhesive layer is made long in the vertical direction so that the sticky note does not easily detach when attached to a page of a book, that is, in use.

In such a configuration, since the adhesive layer only exists discontinuously in the lateral direction, the adhesive force in the lateral direction lowers compared to the conventional configuration during use. Therefore, the possibility that the sticky note gets detached from the attached portion during use becomes high.

Furthermore, although the adhesive layer is not continuous in the lateral direction, curving may also occur since the adhesive layer extends in the detaching direction. That is, although the area of the adhesive layer reduces and the adhesive force lowers, the adhesive force in the detaching direction is substantially the same in the extending direction of the adhesive layer, and thus the adhesive force acts to hold the curving of the paper strip at the end region of the paper strip provided with the adhesive layer. Therefore, the drawback during use is not significantly improved because of such curving and lowering in adhesive force.

### SUMMARY OF THE INVENTION

In view of the foregoing problem, it is an object of the present invention to provide a paper with adhesive capable of maintaining predetermined adhesive force without the region corresponding to the adhesive layer curving during use.

A paper with adhesive according to the present invention relates to a paper with adhesive including an adhering part applied with adhesive and a non-adhering part where a base material is exposed on one surface including a peripheral edge, wherein the adhering part includes a plurality of unit adhering regions applied with adhesive in a set shape and arranged spaced apart from one another, and the non-adhering part is formed into a mesh form between the unit adhering regions and also formed along at least one part of the peripheral edge.

According to such a configuration, when a plurality of papers with adhesive are stacked in a releasable manner and one of the papers with adhesive is raised from the non-adhering part side to separate it from the stacked plurality of papers with adhesive, a portion (unit adhering region) that holds the stress generated in the paper with adhesive and a portion (non-adhering part) that cannot hold the stress become adjacent to each other since the adhering part has the unit adhering region configuring the adhering part surrounded by the non-adhering part in the mesh form. That is, the stress generated in the adhesive is discontinuously divided in a separating direction. As a result, the adhering part will not hold the curving of the paper with adhesive, and thus the separated paper with adhesive maintains a substantially flat shape without being curved. Therefore, in the usage state of the separated paper with adhesive, rising from the side of the non-adhering part formed on at least one part of the peripheral edge can be suppressed.

In order to easily adjust the ratio of the total area of the unit adhering regions in the adhering part to the area of the non-adhering part, the unit adhering region preferably has a circular, elliptical, or polygonal shape.

Furthermore, in order to avoid a boundary portion between the adhering part and the non-adhering part formed along one part of the peripheral edge and serving as a turning-margin part from becoming linear to avoid linear fold reformation (warp reformation) from being made at the boundary portion or to prevent curving through the separating task, the non-adhering part may include a first non-adhering region formed in a mesh form between the unit adhering regions and a second non-adhering region formed along at least one part of the peripheral edge and serving as a turning-margin part, and the unit adhering regions arranged at a boundary portion with the second non-adhering region out of the plurality of unit adhering regions may have the same shape as the unit adhering regions arranged at portions spaced apart from at least the peripheral edge. Accordingly, when separating the paper with adhesive arranged on the outermost part (e.g., uppermost part) of the papers with adhesive in a stacked state from other papers with adhesive and attaching the same to a specific page of a book and the like for use, occurrence of rising (warp or curve of the paper with adhesive) caused by the fold reformation is prevented, whereby the paper with adhesive is less likely to be detached and thus excels in practicability.

The limitation of “the unit adhering regions arranged at a boundary portion with the second non-adhering region have a same shape as the unit adhering regions arranged at portions spaced apart from at least the peripheral edge” is to clarify that in a case where one part of the unit adhering region arranged at the portion different from the boundary portion and at the portion contacting the peripheral edge is cut along the peripheral edge (e.g., semicircular if originally circular), the unit adhering region is not in the same shape as the partially cut unit adhering region. Furthermore, of the unit adhering regions arranged at the boundary portion with the second non-adhering region formed along at least one part of the peripheral edge (e.g., one of the four sides if the peripheral edge has four sides) and serving as the turning-margin part, one part of the unit adhering region arranged at the portion contacting the peripheral edge (e.g., other side intersecting with the above-mentioned one side) may be cut along the peripheral edge.

The modes having the effects substantially the same as the above effects include a mode in which the non-adhering part includes a first non-adhering region formed in a mesh form between the unit adhering regions and a second non-adhering region formed along at least one part of the peripheral edge and serving as the turning-margin part, where a boundary portion unit adhering region group including the unit adhering regions arranged at the boundary portion with the second non-adhering region out of the plurality of unit adhering regions is made with nonlinear cut in a direction substantially orthogonal to a turning direction.

Here, the “turning direction” is a direction of turning when detaching the paper with adhesive on the outermost part of the plurality of stacked papers with adhesive from the other papers with adhesive. Even if the boundary portion unit adhering region group or a collection of the unit adhering regions facing the second non-adhering region is cut, the boundary portion of the adhering part and the second non-adhering region serving as the turning-margin part is avoided from becoming linear when the cutting line is in a curve form, wave form, or V-shape, whereby a linear fold reformation (warp reformation) is less likely to be made at the boundary portion through the separating task (turning task), curving of the paper with adhesive can be suppressed, and satisfactory attached state with respect to a predetermined page can be maintained.

Moreover, a paper with adhesive according to the present invention relates to a paper with adhesive including an adhering part applied with adhesive and a non-adhering part where a base material is exposed on one surface including a peripheral edge, wherein the non-adhering part includes a plurality of unit non-adhering regions formed along at least one part of the peripheral edge and arranged spaced apart from one another with the base material exposed in a set shape, and the adhering part is formed in a mesh form between the unit non-adhering regions.

In such a configuration, the unit non-adhering region preferably has a circular or polygonal shape.

The polygonal shape of the unit adhering region and the unit non-adhering region is preferably regular pentagon, regular hexagon, or Y-shape.

The adhesive in the present invention includes an adhesive enabling attachment of the paper with adhesive in a detachable manner.

The present invention is configured as described above, where one paper with adhesive separated from the stacked papers with adhesive is prevented from being curved. Therefore, rising of the paper with adhesive does not occur when the paper with adhesive attached for use, and detachment of the paper with adhesive can be suppressed.

### BRIEF DESCRIPTION OF THE DRAWINGS

FIG. 1 is a perspective view of a first embodiment according to the present invention;

FIG. 2 is a plan view showing a back surface of a paper with adhesive according to the first embodiment;

FIG. 3 is a plan view showing a back surface of a paper with adhesive according to a first variation of the first embodiment;

FIG. 4 is a plan view showing a back surface of a paper with adhesive according to a second variation of the first embodiment;

FIG. 5 is a plan view showing a back surface of a paper with adhesive according to a third variation of the first embodiment;

FIG. 6 is a plan view showing a back surface of a paper with adhesive according to a first example of the third variation of the first embodiment;

FIG. 7 is a plan view showing a unit adhering region according to the third variation of the first embodiment;

FIG. 8 is a plan view showing a back surface of a paper with adhesive according to a second embodiment of the present invention;

FIG. 9 is a plan view showing a back surface of a paper with adhesive according to a third embodiment of the present invention;

FIG. 10 is a plan view showing a back surface of a paper with adhesive according to a fourth embodiment of the present invention;

FIG. 11 is an illustration corresponding to FIG. 10 showing one variation of the fourth embodiment according to the present invention;

FIG. 12 is an illustration corresponding to FIG. 10 showing another variation of the fourth embodiment according to the present invention;

FIG. 13 is a plan view showing a back surface of a paper with adhesive according to a fifth embodiment of the present invention;

FIG. 14 is an illustration corresponding to FIG. 13 showing one variation of the fifth embodiment according to the present invention;

FIG. 15 is an illustration corresponding to FIG. 10 showing one variation common to the first, third, fourth, and fifth embodiments according to the present invention; and

FIG. 16 is an illustration corresponding to FIG. 2 showing one variation common to the first, third, fourth, and fifth embodiments according to the present invention.

### DETAILED DESCRIPTION OF THE PREFERRED EMBODIMENTS

First to fifth embodiments according to the present invention will now be described with reference to the drawings.

### First Embodiment

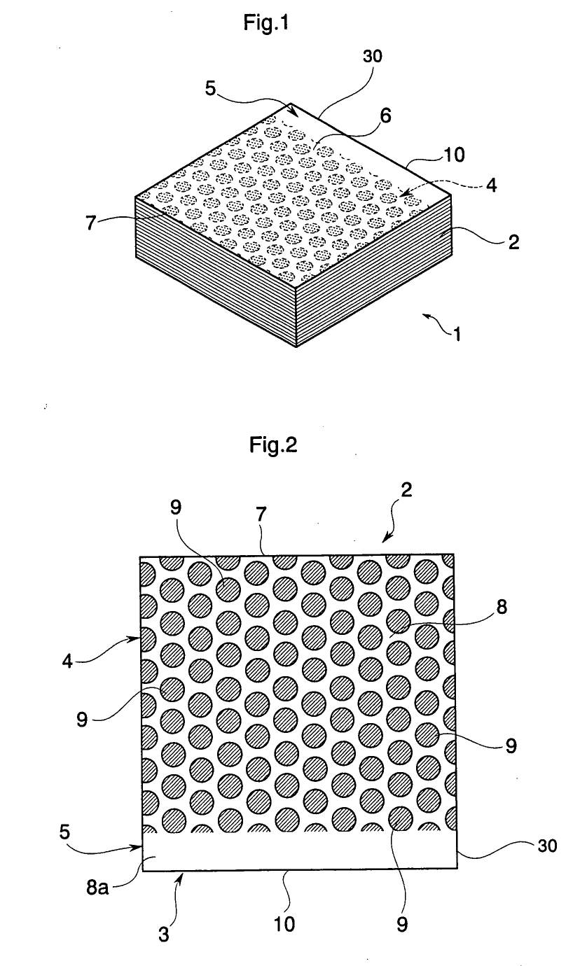

As shown in FIG. 1, sticky notes 1 according to a first embodiment is formed by stacking a plurality of paper strips with adhesive (hereinafter abbreviated as paper strip) 2 having a substantially square shape in a plan view each which is a paper with adhesive. The sticky notes 1 refer to stacked paper strips 2 with adhesive, but each paper strip 2 itself acts as a sticky note in use. Each paper strip 2 has an adhering part 4 and a non-adhering part 5 formed on a back surface 3 or one surface, and a surface 6 or the other surface is performed with coating so that the stacked paper strips 2 can be easily detached. A well-known coating process in the field may be applied. Needless to say, the shape of the paper strip is not limited to a square.

The adhering part 4 is arranged on one side (hereinafter, this side is referred to as a “first end 7”) of a peripheral edge 30 of the back surface 3. In the first embodiment, the adhering part 4 includes a plurality of unit adhering regions 9 having a shape set to a circular shape on which the adhesive is applied, as shown in FIG. 2. In the present embodiment, the diameter of each unit adhering region 9 of a circular shape is set to 4.5 mm. Unit adhering regions 9 are arranged spaced apart from one another at predetermined intervals in the lateral direction and in the vertical direction of the paper strip 2 in the adhering part 4. As a result, a first non-adhering region 8 of a mesh form is formed between the unit adhering regions 9.

On the other hand, the non-adhering part 5 includes the first non-adhering region 8, and a second non-adhering region 8a arranged on a second end 10 side facing the first end 7 of the peripheral edge 30 of the back surface 3 and serving as a turning-margin part. The first non-adhering region 8 continuing in the mesh form is connected to the second non-adhering region 8a. The non-adhering part 5 has a smaller area than the adhering part 4. The non-adhering part 5 (specifically, the second non-adhering region 8a) formed at the peripheral edge 30 preferably has as narrow a width as possible, and is set to have a width allowing easy selection of one of the stacked paper strips 2. This is to have the adhering part 4 occupy most of the area of the back surface 3 during use, so that substantially the entire back surface 3 can be attached to a page of a book, a document, or a cover sheet of a file to which the paper strip 2 is to be attached, and the paper strip 2 is prevented from partially rising. Specifically, the non-adhering part 5 (second non-adhering region 8a) formed in the peripheral edge 30 is formed from the second end 10 side towards the first end 7 side so that the base material of the paper strip 2 is exposed for the area corresponding to 1.5 to 2 lines of the unit adhering region 9, for example.

In such a configuration, the adhering part 4 and the non-adhering part 5 are formed on the back surface 3 of the paper strip 2 with the total area of the plurality of unit adhering regions 9 with respect to the area of the first non-adhering region 8 in the adhering part 4 set to one to two times. The ratio of the total area of the unit adhering regions 9 to the area of the first non-adhering region 8 is adjusted by adjusting the size, changing the density (number), or simultaneously changing the size and the density of the unit adhering region 9 in the adhering part 4 having a set predetermined area. The adjustment of the area ratio affects the adhesive force at the time of use, and thus is adjusted to such adhesive force that the paper strip 2 can be easily detached from the surface 6 and is not easily detached from the surface of a non-coated sheet and the like. The diameter of each unit adhering region 9 is preferably set within the range of 4.5 mm±1.5 mm.

The plurality of paper strips 2 having such a configuration are stacked with the adhering part 4 facing the same direction, that is, the lower side to form the sticky notes 1. That is, the paper strip 2 is stacked by superposing the adhering part 4 on the surface 6 performed with coating of the underlying paper strip 2 with the respective first ends 7 aligned. Therefore, each paper strip 2 is stacked with the adhering part 4 and the surface 6 contacting each other, whereby each paper strip 2 can be detached with external force smaller than the adhesive force at the non-coated surface not performed with the coating process such as paper of the adhering part 4.

In use, when the paper strip 2 is detached by putting the finger on the non-adhering part 5 (specifically, the second non-adhering region 8a serving as the turning-margin part), if external force for detaching is applied on the paper strip 2, stress is generated in the paper strip 2 according to the external force. However, since each unit adhering region 9 forming the adhering part 4 is surrounded by the first adhering region 8, that is, the non-adhering part 5 not applied with adhesive in the mesh form, stress does not continue in the direction of detaching the paper strip 2, and thus, the paper strip 2 is less likely to curve (curl). Furthermore, since the unit adhering regions 9 are separated by the first non-adhering region 8 in terms of adhesive, the adhesive does not act to reinforce the curved paper strip 2. Therefore, although the adhesive is applied to the adhering part 4 that occupies most of the back surface 3 of the paper strip 2, the paper strip 2 does not curve by the adhesive force of the adhesive. Therefore, in use, the paper strip 2 can be attached without rising from the paper, the cover paper, and the like, and is prevented from being detached.

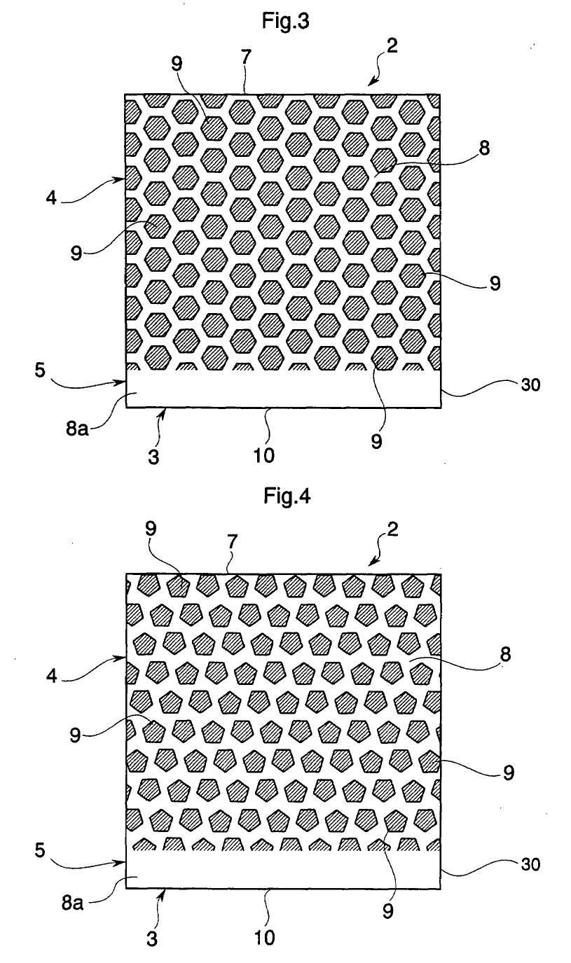

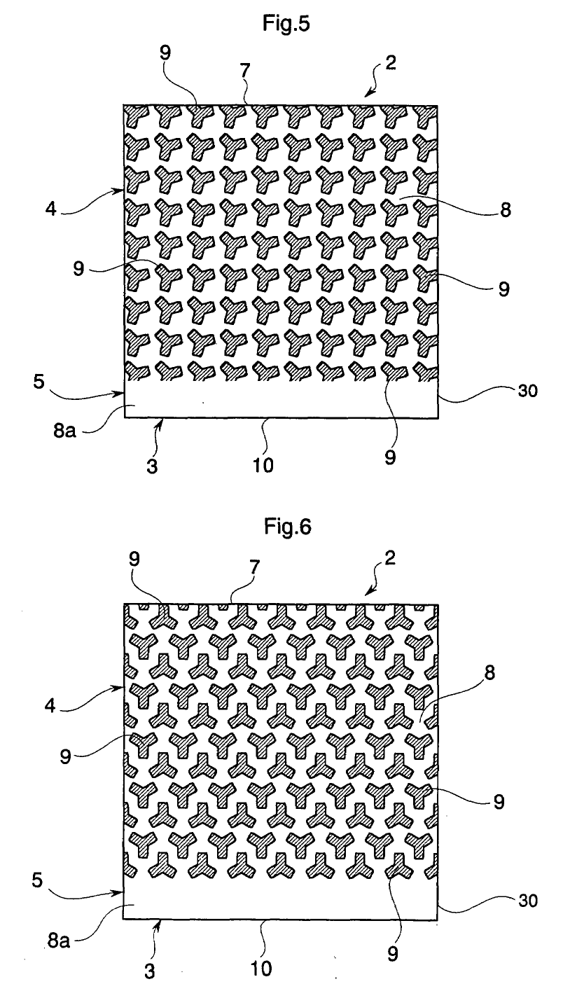

The unit adhering region 9 is not limited to a circular shape as described above. For instance, the unit adhering region 9 may have an elliptical shape, a regular hexagon or a polygonal shape (first variation) as shown in FIG. 3, a regular pentagon (second variation) as shown in FIG. 4, or a Y-shape (third variation) as shown in FIG. 5. If the unit adhering region 9 is of a regular pentagon, a configuration of arranging all the unit adhering regions 9 in the same direction may be adopted, in addition to the second variation in which the unit adhering regions 9 adjacent in the lateral direction of the paper strip 2 are rotated by 36 degrees as shown in FIG. 4.

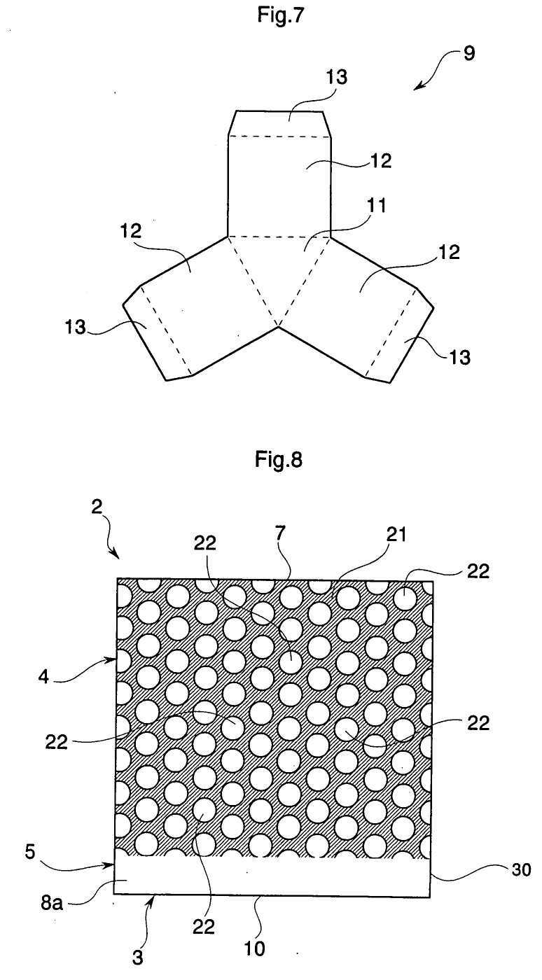

As the configuration employing the unit adhering region 9 of a Y-shape in the third variation, there can be named the third variation having a configuration of arranging all the unit adhering regions 9 in the same direction, and a first example of the third variation (shown in FIG. 6) having a configuration of alternately arranging one group where the unit adhering regions 9 are arranged directed towards the second end 10 on a straight line parallel to the first end 7 and another group where the unit adhering regions 9 are arranged directed towards the first end 7 on a straight line parallel to the first end 7 in the direction of the second end 10. Specifically, as shown in FIG. 7, the Y-shaped unit adhering region 9 is formed into a shape in which an arm part 12 having a substantially square shape is connected to each side of a central part 11 having an equilateral triangle shape, and a distal end 13 having a trapezoidal shape is connected to a distal end of the arm part 12.

In the first to third variations described above also, the adhesive force of the adhering part 4 can be adjusted by changing the size and the density of each unit adhering region 9 as described in the first embodiment.

### Second Embodiment

The sticky notes 1 according to a second embodiment has a configuration in which the functions of the unit adhering region 9 configuring the adhering part 4 and of the first non-adhering region 8 in the mesh form in the first embodiment are interchanged with the same shape as in the first embodiment. Configurations other than the configuration of the adhering part 4 of the paper strip 2 to be used in the second embodiment are the same as those of the first embodiment, and thus the same reference numerals are given and detailed description thereof will be omitted.

Specifically, as shown in FIG. 8, an adhering region 21 applied with adhesive in a mesh form and a plurality of unit non-adhering regions 22 arranged within the mesh of the adhering region 21 and having the base material exposed are formed on the back surface 3 of the paper strip 2 configuring the sticky notes 1. That is, the region corresponding to the unit adhering region 9 in the first embodiment becomes the unit non-adhering region 22, and the region corresponding to the first non-adhering region 8 becomes the adhering region 21. Adjacent to the adhering part 4, a band-shaped non-adhering part (second non-adhering region 8a) serving as a turning-margin part is formed on the second end 10 side configuring the peripheral edge 30.

Also in the case of the second embodiment, the adhesive force of the adhering part 4 is adjusted by adjusting the ratio of the area of the adhering region 21 to the total area of the unit non-adhering region 22. In the second embodiment, the area of the adhering region 21 in the mesh form can be increased or decreased by changing the size, the density, or both the size and the density of the unit non-adhering region 22.

Effects that are the same as those of the first embodiment are obtained with such a configuration.

In the second embodiment also, variations can be contrived in a similar manner as in the first embodiment.

### Third Embodiment

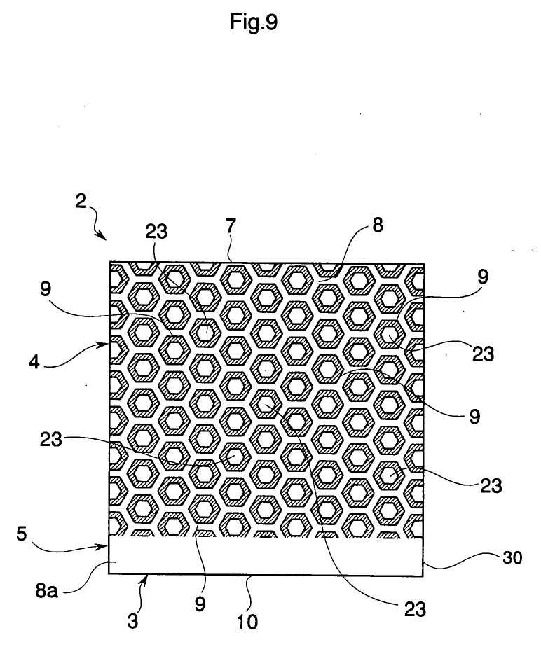

In a third embodiment, an intraregional non-adhering region 23 where the base material of the paper strip 2 is exposed is formed in the unit adhering region 9 of the above described first variation of the first embodiment, as shown in FIG. 9. Specifically, the intraregional non-adhering region 23, which is similar to the unit adhering region 9 in the first variation of the first embodiment, of a hexagonal shape smaller than the hexagonal shape of the unit adhering region 9 is formed in the unit adhering region 9 with the same center. In other words, in the third embodiment, annular unit adhering regions 9 are arranged at predetermined intervals. The size of the intraregional non-adhering region 23 reduces the adhesive force of the unit adhering region 9, and thus is preferably about ¼ of the unit adhering region 9.

According to such a configuration, the unit adhering regions 9 are further dispersed compared to the first variation of the first embodiment. As a result, the stress generated when detaching the paper strip 2 is further finely divided, and thus the paper strip 2 does not curve. Therefore, effects that are the same as those of the first embodiment are obtained in the third embodiment as well.

The configuration of the third embodiment can be applied to the first embodiment and the second and third variation thereof.

### Fourth Embodiment

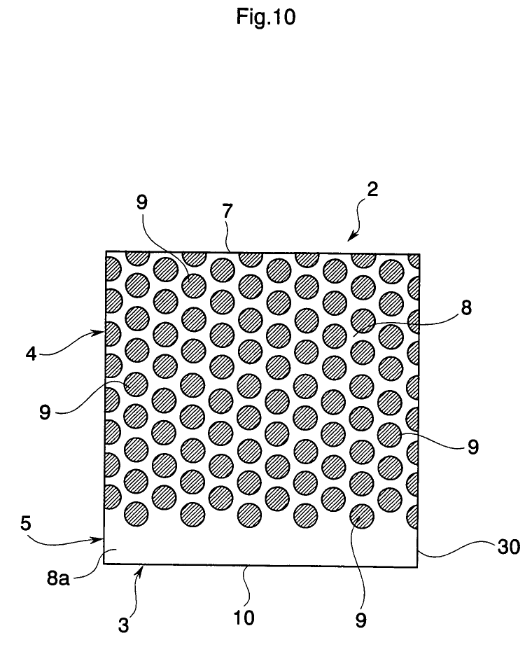

As shown in FIG. 10, a fourth embodiment differs from the first and third embodiments in that the unit adhering region 9 arranged at the boundary portion with the second non-adhering region 8a serving as the turning-margin part has the same shape as the unit adhering region 9 arranged at portions spaced apart from the peripheral edge 30 to avoid the boundary portion between the second non-adhering region 8a of the non-adhering part 5 formed along at least one part of the peripheral edge 30 and serving as the turning-margin part and the adhering part 4 from becoming linear.

That is, if each unit adhering region 9 has a circular shape, the unit adhering region 9 arranged at the boundary portion with the second non-adhering region 8a serving as the turning-margin part of the non-adhering part 5 also has a complete circular shape. The unit adhering region 9 arranged at the portion contacting portions other than the second end 10 of the peripheral edge 30 of the unit adhering regions 9 arranged at the boundary portion with the second non-adhering region 8a may have one part cut off along the peripheral edge 30. That is, the boundary portion of the adhering part 4 including the plurality of unit adhering regions 9 and the second non-adhering region 8a serving as the turning-margin part merely needs to be avoided from becoming linear.

Therefore, compared to the mode shown in FIG. 2, the boundary portion of the second non-adhering region 8a serving as the turning-margin part and the adhering part 4 does not become linear, and consequently, a linear fold reformation (warp reformation) is less likely to be made at the boundary portion during the task of separating the paper strip 2 in a stacked state from the other paper strips 2, occurrence of rising caused by the fold reformation is prevented when attaching the separated paper strip 2 to a specific page and the like of a book for use, the paper strip will not fall off unexpectedly, and therefore, excels in practical use. Obviously, similar to the first and third embodiments, since a configuration of “forming the adhering part 4 by the plurality of unit adhering regions 9 dispersed from one another” is adopted, the stress generated when detaching the paper strip 2 is finely divided, the paper strip 2 does not curve, and effects that are the same as those of the first embodiment and the like are also obtained in the fourth embodiment.

The configuration of the fourth embodiment can be applied to the first to third variations of the first embodiment and the third embodiment.

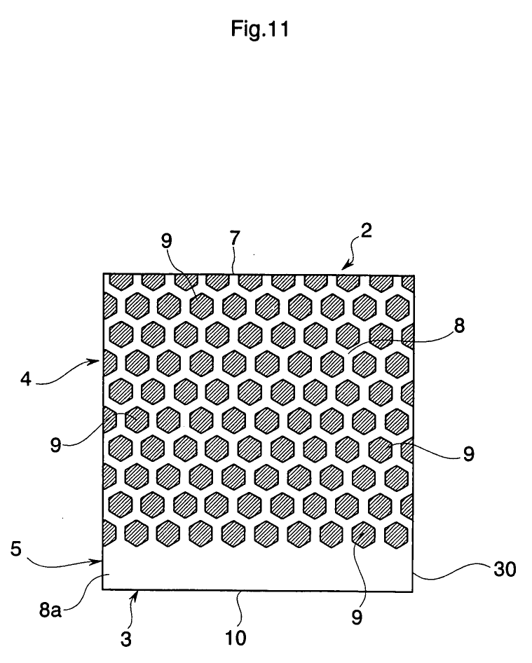

For instance, if the unit adhering region 9 is of a polygonal shape as shown in FIGS. 6 and 11 (Y-shape in FIG. 6, regular hexagon in FIG. 11), each unit adhering region 9 arranged at the boundary portion with the second non-adhering region 8a serving as the turning-margin part is arranged such that the corner, that is, portion other than the side, of each unit adhering region 9 is directed towards the peripheral edge (second end 10 in the illustrated example) provided with the second non-adhering region 8a serving as the turning-margin part, whereby the boundary portion is avoided from becoming linear, and the above effects are obtained.

In the fourth embodiment also, the adhesive force of the paper strip 2 can be adjusted by adjusting the size, changing the density (number), or simultaneously adjusting both the size and the density of each unit adhering region 9.

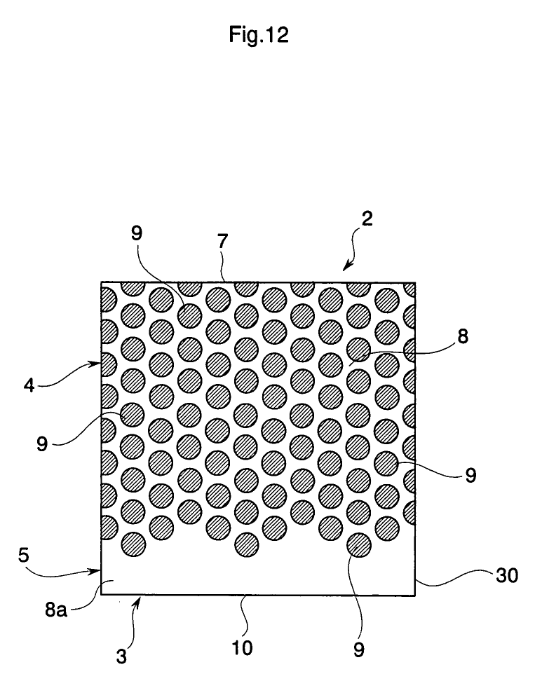

In particular, as shown in FIG. 12, the density of the unit adhering regions 9 arranged at the boundary portion with the second non-adhering region 8a of the non-adhering part 5 serving as the turning-margin part may be lower than the density of the unit adhering regions 9 arranged at other portions. According to such a mode, the boundary portion with the second non-adhering region 8a is more reliably avoided from becoming linear, and the above described effects become more effective.

### Fifth Embodiment

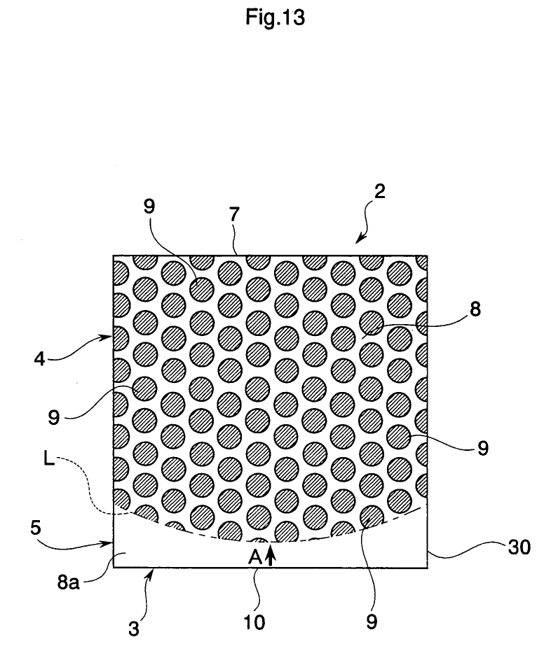

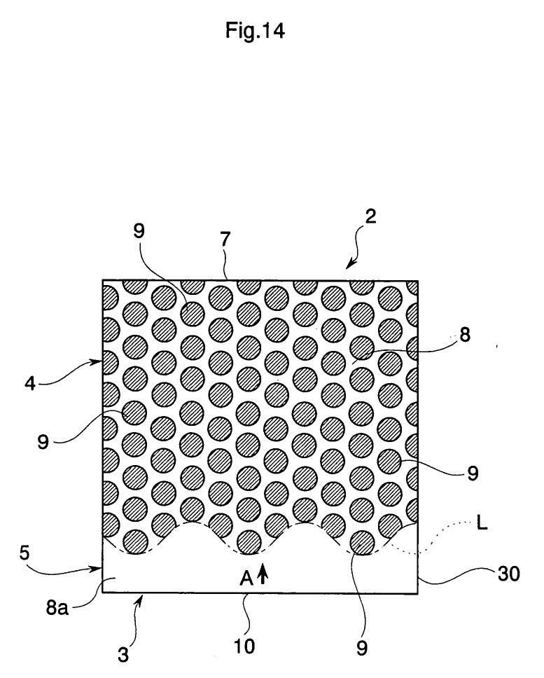

As shown in FIGS. 13 and 14, a fifth embodiment has features in that the boundary portion unit adhering region group consisting of the unit adhering regions 9 arranged at the boundary portion with the second non-adhering region 8a of the non-adhering part 5 serving as the turning-margin part out of the plurality of unit adhering regions 9 is not linearly cut in a direction substantially orthogonal to the turning direction (direction of arrow A shown in FIGS. 13 and 14). FIG. 13 shows a mode in which the boundary portion unit adhering region group is divided by a virtual cutting line L of a curve form (partially circular arc shape), and FIG. 14 shows a mode in which the boundary portion unit adhering region group is cut by a virtual cutting line L of a wave form. Here, the “boundary portion unit adhering region group” is a collection of the unit adhering regions 9 facing the second non-adhering region 8a out of the plurality of unit adhering regions 9, that is, a collection of the unit adhering regions 9 facing (lying along) the virtual cutting line L.

In this configuration also, there can be obtained effects substantially the same as those of the mode shown in the fourth embodiment, that is, avoiding the boundary portion of the adhering part 4 and the second non-adhering region 8a from becoming linear, linear fold reformation (warp reformation) substantially orthogonal to the turning direction being less likely to be made at the boundary portion when turning the paper strip 2 positioned at the outermost part (uppermost part) to separate it from the other paper strips 2, preventing the occurrence of rising caused by such fold reformation when attaching the turned paper strip 2 to a specific page and the like of a book for use, and being prevented from falling unexpectedly, and thus excelling in practical use.

The configuration of the fifth embodiment can be applied to the first to third variations of the first embodiment and the third embodiment.

In the fifth embodiment, it is only necessary that the boundary portion unit adhering region group is not linearly cut in a direction substantially orthogonal to the turning direction, and thus the boundary portion unit adhering region group may be partitioned by a virtual cutting line of a V-shape or a zigzag form in addition to the curve form or wave form.

In the fifth embodiment, the adhesive force of the paper strip 2 can be adjusted by adjusting the size, changing the density (number), or simultaneously adjusting both the size and the density of each unit adhering region 9.

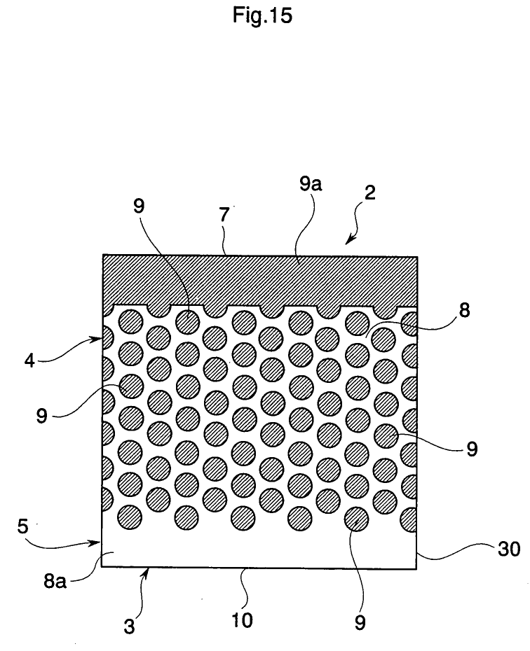

In each embodiment, as shown in FIG. 15, for example, a belt-shaped adhering region 9a applied with adhesive over the entire surface may be formed at a portion different from the portion provided with the non-adhering part 5 (specifically, the second non-adhering region 8a) serving as the turning-margin part out of the peripheral edge 30. The belt-shaped adhering region 9a is preferably formed at a portion (the first end 7 in the illustrated example) facing the portion (the second end 10 in the illustrated example) provided with the second non-adhering region 8a. The area of the band-shaped adhering region 9a obviously may be appropriately changed according to usability, application, and the like.

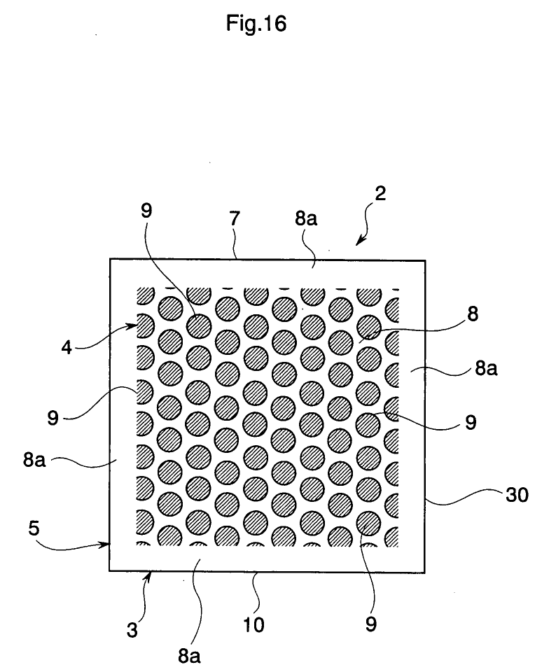

In each embodiment described above, the non-adhering part 5 (the second non-adhering region 8a) in the peripheral edge 30 has been described as being provided on the second end 10 side but may be provided along all the sides of the paper strip 2 so as to surround the region arranged with the unit adhering regions 9, that is, the adhering part 4, as shown in FIG. 16. That is, it is sufficient to form the non-adhering part 5 (the second non-adhering region 8a) formed on the peripheral edge 30 on at least one part of the peripheral edge 30 as shown in each embodiment, and detachment can be carried out in various directions by adopting such a configuration. Therefore, a user can detach the paper strip 2 by picking up any part of the peripheral edge 30 of the paper strip 2 without being regulated for the location to pick up the paper strip 2, and thus the convenience in detaching the paper strip 2 is enhanced. FIG. 16 shows one in which the non-adhering part 5 (the second non-adhering region 8a) is formed into a belt shape along four sides of the paper strip 2, but may be formed along three sides or two sides.

The paper strip 2 according to the present invention may be applied to, e.g., labels, tags and index papers to be used by being detached from a board and the like, in addition to the sticky notes 1 described above.

Furthermore, the specific configuration of each part is not limited to the above embodiments, and various changes and modifications may be made without departing from the scope of the present invention.

What is claimed is:

1. A paper with adhesive comprising an adhering part applied with adhesive and a non-adhering part where a base material is exposed on one surface including a peripheral edge, wherein
the adhering part includes a plurality of unit adhering regions applied with adhesive in a set shape and arranged spaced apart from one another, and
the non-adhering part is formed into a mesh form between the unit adhering regions and also formed along at least one part of the peripheral edge.

2. The paper with adhesive according to claim 1, wherein each unit adhering region has one of a circular shape and an elliptical shape.

3. The paper with adhesive according to claim 1, wherein each unit adhering region has a polygonal shape.

4. The paper with adhesive according to claim 3, wherein the polygonal shape is a regular pentagon.

5. The paper with adhesive according to claim 3, wherein the polygonal shape is a regular hexagon.

6. The paper with adhesive according to claim 3, wherein the polygonal shape is a Y-shaped polygon.

7. The paper with adhesive according to claim 1, wherein
the non-adhering part includes a first non-adhering region formed into a mesh form between the unit adhering regions, and a second non-adhering region formed along at least one part of the peripheral edge and serving as a turning-margin part, and
unit adhering regions arranged at a boundary portion with the second non-adhering region out of the plurality of unit adhering regions have the same shape as unit adhering regions arranged at portions spaced apart from at least the peripheral edge.

8. The paper with adhesive according to claim 2 wherein
the non-adhering part includes a first non-adhering region formed into a mesh form between the unit adhering regions, and a second non-adhering region formed along at least one part of the peripheral edge and serving as a turning-margin part, and
unit adhering regions arranged at a boundary portion with the second non-adhering region out of the plurality of unit adhering regions have the same shape as unit adhering regions arranged at portions spaced apart from at least the peripheral edge.

9. The paper with adhesive according to claim 3, wherein
the non-adhering part includes a first non-adhering region formed into a mesh form between the unit adhering regions, and a second non-adhering region formed along at least one part of the peripheral edge and serving as a turning-margin part, and
unit adhering regions arranged at a boundary portion with the second non-adhering region out of the plurality of unit adhering regions have the same shape as unit adhering regions arranged at portions spaced apart from at least the peripheral edge.

10. The paper with adhesive according to claim 1, wherein
the non-adhering part includes a first non-adhering region formed into a mesh form between the unit adhering regions, and a second non-adhering region formed along at least one part of the peripheral edge and serving as a turning-margin part, and
a boundary portion unit adhering region group including unit adhering regions arranged at a boundary portion with the second non-adhering region out of the plurality of unit adhering regions is made with nonlinear cut in a direction substantially orthogonal to a turning direction.

11. The paper with adhesive according to claim 2, wherein
the non-adhering part includes a first non-adhering region formed into a mesh form between the unit adhering regions, and a second non-adhering region formed along at least one part of the peripheral edge and serving as a turning-margin part, and
a boundary portion unit adhering region group including unit adhering regions arranged at a boundary portion with the second non-adhering region out of the plurality of unit adhering regions is made with nonlinear cut in a direction substantially orthogonal to a turning direction.

12. The paper with adhesive according to claim 3, wherein
the non-adhering part includes a first non-adhering region formed into a mesh form between the unit adhering regions, and a second non-adhering region formed along at least one part of the peripheral edge and serving as a turning-margin part, and
a boundary portion unit adhering region group including unit adhering regions arranged at a boundary portion with the second non-adhering region out of the plurality of unit adhering regions is made with nonlinear cut in a direction substantially orthogonal to a turning direction.

13. A paper with adhesive comprising an adhering part applied with adhesive and a non-adhering part where a base material is exposed on one surface including a peripheral edge, wherein
the non-adhering part includes a plurality of unit non-adhering regions formed along at least one part of the peripheral edge and arranged spaced apart from one another with the base material exposed in a set shape, and
the adhering part is formed into a mesh form between the unit non-adhering regions.

14. The paper with adhesive according to claim 13, wherein each unit non-adhering region has one of a circular shape and an elliptical shape.

15. The paper with adhesive according to claim 13, wherein each unit non-adhering region has a polygonal shape.

16. The paper with adhesive according to claim 15, where in the polygonal shape is a regular pentagon.

17. The paper with adhesive according to claim 15, wherein the polygonal shape is regular hexagon.

18. The paper with adhesive according to claim 15, wherein the polygonal shape is a Y-shaped polygon.
